(19) United States
(12) Patent Application Publication
(10) Pub. No.: US 2019/0325486 A1
(43) Pub. Date: Oct. 24, 2019

(54) SYSTEM OF PUBLICLY RAISING FUNDS FOR ACTIVITIES

(71) Applicant: WINLIGHT Co., Ltd., Tokyo (JP)

(72) Inventor: Katsuhiro FUJIMOTO, Tokyo (JP)

(73) Assignee: WINLIGHT Co., Ltd., Tokyo (JP)

(21) Appl. No.: 15/979,138

(22) Filed: May 14, 2018

(30) Foreign Application Priority Data
Apr. 20, 2018 (JP) 2018-081471

(51) Int. Cl. G06Q 30/02; G06Q 20/06

(52) U.S. Cl. CPC G06Q 30/0279; G06Q 20/065

(57) ABSTRACT

Problem to be Solved

It is an object of the present invention to provide a system for raising public investments for the purpose of assisting entrepreneurs and enterprises to raise investments in which investors have to take virtually no risk.

Solution

A system for raising investments to fund a business to provide an application software comprising a server connecting an application software provider terminal and an investor terminal via a network; the server comprising a means to register on a database project information, a means to allow said investor terminal to browse said project information, a means to store the money invested on said project by the investors in an investment money pool account, a means to issue to the application software provider activity tokens in a number corresponding to the total amount of investment money, a means to transfer from said investment money pool account to a predetermined payee money to be used for the business to provide the application software, and a means to deduct the activity tokens memorized in the database in a number corresponding to the amount of the transferred money.

### TECHNICAL FIELD

The present invention relates to a system providing services for raising public investments for the purpose of obtaining funds needed for business activities.

### BACKGROUND ART

Fund raising systems for individual entrepreneurs and small-scale enterprises to raise investments from a number of investors are widely known. For example, Patent Document 1 discloses a method of raising public funds for the purpose of producing a video content in which investments on a video content are invited for a predetermined minimum number of investment units and invitation period, and in case a fund is established, payment is made by the investors and the producer receives the fund. Patent Document 2 to 4 also disclose similar systems.

### PRIOR ART DOCUMENT

### Patent Document

Patent Document 1: Japanese Patent Laid-open No. 2002-117261.
Patent Document 2: Japanese Patent Laid-open No. 2002-259633.
Patent Document 3: Japanese Patent Laid-open No. 2002-73971.
Patent Document 4: Japanese Patent Laid-open No. 2003-16272.

### BRIEF SUMMARY OF THE INVENTION

### Problems to be Solved by the Invention

In the prior-art system for raising public investments, however, investment money is delivered to entrepreneurs or enterprises. In such a system, there is a risk that malicious entrepreneurs or enterprises abscond away with invested money or do not use invested money for intended use.

In businesses earning profits from providing services such as application softwares through a communication network, it is possible to effectively increase profits by boosting recognition using advertisement. Even in case of non-profit business, advertisement is effective for boosting recognition such that application softwares gain a number of users. In such cases, funds for advertisement expenses are necessary. In many cases, however, individual entrepreneurs and small-scale enterprises do not have adequate funds for advertisement expenses to request advertisement agencies to place large scale advertisements. Thus, there is a demand for a scheme for raising investments from investors in order to fund advertisement expenses needed to place advertisements using advertisement agencies.

On the other hand, in the advertisement business, the dealings of entrepreneurs and enterprises (or advertisers), investors investing on advertisers and advertisement agencies have been generally limited within their nationality, business areas and/or currencies. It requires complicated procedures and additional costs to have dealings beyond such restriction.

In consideration of the above problems of the prior art systems, it is an object of the present invention to provide a system for raising public investments for the purpose of assisting entrepreneurs and enterprises to raise investments in which investors have to take virtually no risk.

It is another object of the present invention to provide a system for raising public investments for the purpose of comprehensively assisting a flow of advertising business in which an entrepreneur or an enterprise (an advertiser) raises investments to fund advertisement expenses and requests an advertisement agency to place advertisements using the invested money.

It is still another object of the present invention to provide a system for raising public investments in which advertisers, entrepreneurs, enterprises and advertisement agencies can participate with no need to take complicated procedures and pay additional costs and with no restriction of nationality, business areas and/or currencies.

### Means for Solving the Problems

As a solution to the above-mentioned problems, the present invention has been accomplished, the details of which are described below.

According to the present invention, there is provided a public investment raising system for raising investments to fund a business to provide an application software comprising an application software provider terminal for providing an application software, at least one investor terminal for investing money to fund the business and a server connecting said application software provider terminal and said investor terminal via a network; said server comprising a means to register on a database application information regarding an application software received from said application software provider terminal, a means to register on a database project information regarding a project of raising investments to fund a business to provide said application software, which includes investment conditions, received from said application software provider terminal, a means to allow said investor terminal to browse said project information registered in the database via the network, a means to store the money invested on said project by the investors in an investment money pool account made for said project in the database, a means to issue to the application software provider activity tokens in a number corresponding to the total amount of investment money stored in said investment money pool account when the project satisfies said investment conditions become effected and to memorize the number of issued activity tokens in the database, a means to transfer from said investment money pool account to a predetermined payee money to be used for the business to provide the application software, and a means to deduct the activity tokens memorized in the database in a number corresponding to the amount of the transferred money.

The present invention is also characterized in that said server further comprises a means to issue to the investors project tokens in a number corresponding to the amount of money each investor has invested and to memorize the number of issued project tokens in the database.

The system of the present invention is also characterized in that said server further comprises a means to send to said application software provider terminal SDKs to be incorporated in said application software, which has been registered in said server, for the purpose of retrieving performance information of said application software, a means to retrieve the performance information of said application software from said SDKs incorporated in said application software, a means to generate a KPI information based on the retrieved performance information, and a means to allow said investor terminal to browse said KPI information.

The system of the present invention is also characterized in that said server further comprises, in case said application software comprises a monetization function, said performance information is that of sales proceeds and said SDKs are incorporated in the monetization function of said application software, a means to retrieve information of the sales proceeds from said SDKs and to generate KPI information based on the retrieved information of the ales proceeds.

The system of the present invention is also characterized in that said server further comprises a means to transfer sales distribution money, which is part of the sales proceeds of said application software, paid by said application software provider into a dividend account made for said project in the database, and a means to make payment of dividends pooled in said dividend account to the investors.

The system of the present invention is also characterized in that said server further comprises a means to issue to the investors project tokens in a number corresponding to the amount of money each investor has invested and to memorize the number of issued project tokens in the database, said dividends being decided on the basis of the numbers of project tokens owned by the investors.

The system of the present invention is also characterized in that said server further comprises a means to calculate expected dividends on the basis of the amount of said sales distribution money, the number of project tokens owned by each investor and the total number of issued project tokens, and a means to allow said investor terminal to browse the calculated expected dividends via the network.

The system of the present invention is also characterized in that said means to store the money invested on said project by the investors in said investment money pool account transfers investment money from investor wallets made in the database to said investment money pool account, and said means to make payment of dividends pooled in said dividend account to the investors transfers money from aid investment money pool account to said investor wallets.

The system of the present invention is also characterized in that, in case the investment money in a virtual currency is transferred into said investor wallets, the dividends in any of one of virtual currencies are paid into from said dividend account to said investor wallets.

The system of the present invention is also characterized in that it is possible to select one from multiple kinds of virtual currencies with which payment is made from said dividend account to said investor wallets.

The system of the present invention is also characterized in that, in case the investment money in a virtual currency is transferred into said investor wallets, the dividends in any of one of real currencies are paid into from said dividend account to said investor wallets.

The system of the present invention is also characterized in that it is possible to select one from multiple kinds of real currencies with which payment is made from said dividend account to said investor wallets.

The system of the present invention is also characterized in that the fund for the business is used for advertisements fees and said payee is an advertisement agency or an advertisement publisher.

The system of the present invention is also characterized in that said server further comprises a means to connect to at least one advertisement agency terminal via a network, a means to register on the database sub-project information regarding one or more sub-projects received from said application software provider terminal, said sub-projects inviting advertisement agencies to place advertisements for which advertisements fees are allocated in the amount obtained by dividing the total amount of invested money by the number of times of advertisements are to be placed, a means to allow said advertisement agency terminal to browse said sub-project information registered in the database via the network, a means to receive from said advertisement agency terminal application to said sub-projects and to allow said advertisement agency terminal to browse the applications received from said advertisement agency terminal, a means to receive from said application software provider terminal information of applications made to said sub-projects by said advertisement agency terminal and of the advertisement fees and to store the information in the database, and a means to transfer money from said investment money pool account to the advertisement agencies according to the information of the advertisement fees stored in the database.

### Effects of the Invention

In the public investment raising system for raising investments to fund a business to provide an application software according to the present invention, the service administrator transfers the invested money not to the application service provider but directly to the payee related to the business, thereby getting rid of the risks on the investors side and making it easier for the application service provider to raise investments.

In case the fund for the business is used for advertisements fees, the major parties concerned in the business such as the investors, the advertisers (entrepreneurs Or enterprises), the advertising agencies and advertisement publishers can cooperate with one another to build up an efficient flow of advertising business.

Furthermore, in the public investment raising system for raising investments to fund a business to provide application software according to the present invention, the above-mentioned major parties concerned in the business can take part in the advertising business without having difficulties in the differences of nationality, locality and/or currency.

Thus, the system of the present invention enables to raise investments to fund the business extensively from all over the world, to place advertisements with the invested money, to promote the business and to eventually return profits to the investors in some way.

The system of the present invention is particularly advantageous in case it uses virtual currencies in receiving investment money and/or paying dividends since virtual currencies are universal currencies and do not cost remittance fees.

### BRIEF DESCRIPTION OF THE DRAWINGS

FIG. 1 is a view explaining the schema of an exemplary business models based on the public investment raising system for raising investments to fund a business, in which the fund for the business is used for advertisements fees.

FIG. 2 is view showing each process step shown in FIG. 1 in a chronological order.

FIG. 3 is a view schematically showing an exemplary configuration of the overall network system including the system of the present invention.

FIG. 4 is a schematic block diagram showing the major functions of the host server shown in FIG. 3.

FIG. 5 is a view showing examples of the tables stored in the application software database shown in FIG. 3.

FIG. 6 is a view showing examples of the tables stored in the project database shown in FIG. 3.

FIG. 7 is a view showing examples of the tables stored in the investor database shown in FIG. 3.

FIG. 8 is a view showing examples of the tables stored in the advertisement agency database shown in FIG. 3.

FIG. 9 is a view showing an example of the process flow of registering a project and raising investments in the system of the present invention.

FIG. 10 is a view showing an example of the process flow of placing advertisements and paying advertisement fees in the system of the present invention.

FIG. 11 is a view showing an example of the process flow of transferring sales distribution money.

### BEST MODE FOR CARRYING OUT THE INVENTION

The public investment raising system for raising investments to fund a business according to the present invention is designed to assist entrepreneurs and enterprises in raising investments to fund their businesses from unspecified large number of investors. Preferably, the system of the present invention is designed to assist entrepreneurs and enterprises in placing advertisements through advertisement agencies using the invested money.

The “business” herein referred to in connection with the present invention includes that providing any kind of application software via a network. The application software is typically provided for the purpose of gaining profits, but it may be provided for other purposes. The entrepreneurs and enterprises providing application softwares are hereinafter referred to as “application software providers.”

The usage of money invested for the purpose of funding businesses of application software providers in the system is limited to that determined when initiating the investment raising and it is not allowed to use invested money for other purposes. In case the usage is limited to advertisement, for example, the invested money is used only as advertising expenses to advertise the application software.

A typical example of application software provided for the purpose of gaining profits is that having monetization functions (i.e. functions to gain profits), which can be introduced in user terminals such as smartphones, tablet computers, personal computers, etc. connected to network. Typical examples of monetization functions are meter rate charging, charging per download, setting charging points as well as running advertisements in the form of banners and movies, but there is no limitation to the types of monetization functions to be included in application software.

A typical example of non-profit application software is that for the purpose of making social contribution which is provided for free of charge.

The present invention is preferably realized as an application software for mobile terminals such as smartphones. As this kind of application software can be easily produced without highly technical knowledge these days, it has become common for application software providers to gain profits by uploading application softwares they have produced on application software stores (actually, application software distribution servers) open to networks so as to be downloaded and used by users. In case of application softwares provided for the purpose of gaining profits, profits of the application software providers increase as the degree of recognition of the application softwares rises through the work of advertisement and propagation by word of mouth. Even in case of non-profit application softwares, it is preferable that the degree of recognition of the application softwares rises such that information is widely propagated.

It has thus become common to place advertisements on networks so as to raise the degree of recognition of application softwares. For example, one can place such advertisements through advertisement publishers such as Facebook® and Google®, which provide their server functions to place online advertisements. However, entrepreneurs and small-scale enterprises usually can not afford such advertisement expenses.

By using the system of the present invention, application software providers can raise investments for advertisement expenses of the application software from a number of investors while avoiding the risks since the usage of the invested money is limited. Moreover, by using the system of the present invention, application software providers can efficiently place advertisements through advertisement agencies using the invested money.

It has become common these days to raise investments using the platforms of virtual currencies. Furthermore, it has also become common to raise investments with the use of unique pseudo currencies or pseudo securities called “tokens” as well as the platforms of virtual currencies. In the system of the present invention, in which participants exchange monetary values, it is preferable that virtual currencies or tokens are used. Transference of virtual currencies or tokens is preferably implemented using existing block chain technologies.

The use of block chain technologies makes it easy to exchange monetary values as well as to secure transactions. Virtual currencies are especially preferable in transferring money beyond borders. Although the transaction fees for transference of virtual currencies to be paid to the block chain system providers are not described in the below, the fees are automatically charged to the users.

Despite the above description, the present invention does not exclude the cases in which participants exchange monetary values using the existing platforms of bank transfer or credit cards.

Described hereinafter in detail with reference to the attached figures are the best mode for carrying out a system according to the present invention.

<Business Model Schema>

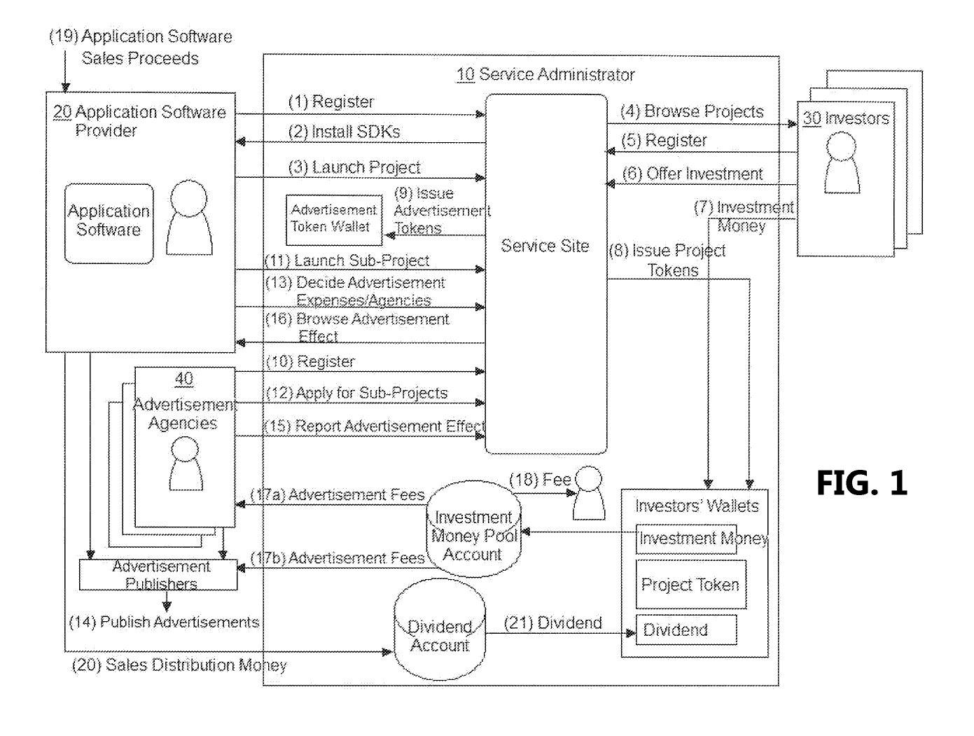

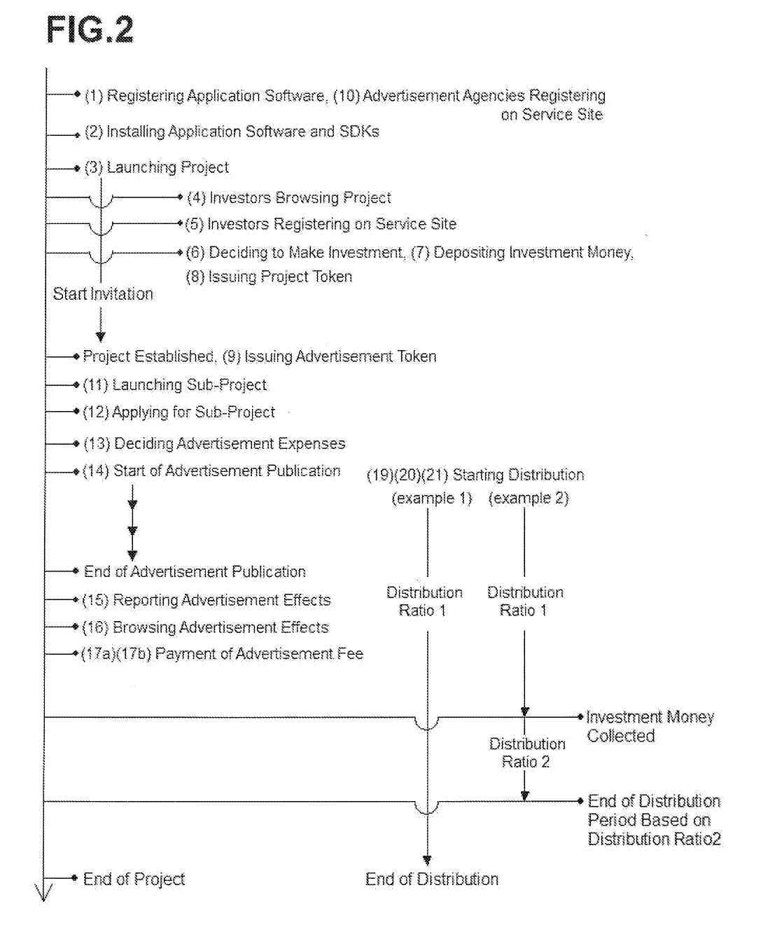

FIG. 1 is a view explaining the schema of an exemplary business models based on the public investment raising system for raising investments to fund a business, in which the fund for the business is used for advertisement. FIG. 2 is view showing each process step shown in FIG. 1 in a chronological order. These figures are presented only for purposes of illustration and they may have a variety of different modes.

A service administrator 10 is a party who installs a server providing functions and services of the system and administrates the operation of the server. An application software provider 20 a party who provides an application software having monetization functions. Investors 30 are parties who invest money on the application software provider to be used for advertisements. Advertisement agencies 40 are parties who receive orders of advertisement from the application software provider 20 and arrange advertisement publishers who take on publishing advertisements.

Below described with reference to FIG. 1 is services of the service administrator 10, which are mainly provided by the server. The service administrator 10 operates a service site which is open to networks. Preferably, the service site is constructed using web application softwares and the application software provider 20, the investors 30 and the advertisement agencies 40 can view the service site on web browsers of their terminals. The service site is equipped with various input-output functions for use by the application software provider 20, the investors 30 and the advertisement agencies 40 respectively. Alternatively, the service site may be constructed using native application softwares instead of web application softwares.

The accounts and wallets of the service administrator 10 shown in FIG. 1 are realized by the functions of databases on storage devices of the system.

Below described is a schema of business models based on the public investment raising system for raising investments to fund a business according to the present invention. The present invention, however, is not limited to the below description.

(1) Registering Application Software

In the system, the application software provider (actually, the terminal of the application software provider) first access the service site and registers its unique information, thereby obtaining its account (typically, a set of an ID and a password). The account is associated with one of advertisement token wallets, which are provided for each application software provider. (The term “advertisement token” and “advertisement token wallet” should be rephrased into more generic terms such as “activity token” and “activity token wallet” in case the usage of the invested money is not limited to advertisement expenses.) Incase the application software provider 20 intends to deal directly with advertisement publishers without using advertisement agencies, such contracts should be made in advance.

(2) Installing Application Software and SDKs

The application software provider 20 registers an application software for which to raise investments. Shown in FIG. 1 is an example in which the application software has monetization functions, specifically setting charging points. After the registration, the application software provider 20 downloads SDKs (Software Development Kits) from the service site and install the SDKs in the application software. The SDKs can be installed into the charging points set in the application software. This enables to automatically send to the service site the sales proceeds information on the charging points in the application software.

Alternatively, the SDKs may be installed into the visitor counting point instead of or in addition to the charging points. In this case, the application software automatically send to the service site the visitor count information on the visitor counting point in the application software. By installing the SDKs into some points in the application software, the service site automatically receives information regarding sales proceeds, number of visitors, etc. of application software. In case of a non-profit application software with out monetization functions, the visitor count information may be considered as performance information.

The service site stores the received sales proceeds information and/or visitor count information, thereby generating KPIs (key Performance Indicators).

In addition to the charging points on which sales proceeds information can be obtained suing the SDKs, the application software may have other monetization functions such as banner advertisement and movie advertisement.

The present invention is also directed to application softwares having monetization functions from which the SDKs can not obtain sales proceeds information. In this case, sales proceeds information can be obtained by other means which enables the application software provider 20 to regularly report sales proceeds information to the service administrator 10.

(3) Launching Project

The application software provider 20 determines investment conditions of a project and registers the project and investment conditions. Once registered, the project is launched. A “project” herein refers to a proposal in which investments are raised in connection with an application software under predetermined conditions. Multiple projects can be launched in connection with one application software, each project being independent. Once s project is registered, information of the project is published on the service site and the investors are allowed to browse the project information.

(4) Investors Browsing Project

The investors 30 (actually, the terminals of the investors) are allowed to browse all or part of the project information without registering on the service site. The project information includes application software information (i.e. details, KPI, etc.), investment conditions and the like. Preferably, the investors are not allowed to browse important information such as KPIs of application softwares before registering on the service site. The registered investors can browse and take into consideration detailed information of application such as KPIs, sales distribution conditions and the like to select which project to invest on.

(5) Investors Registering on Service Site

An investor 30 who uses the system for the first time is required to register its unique information in the service site, thereby obtaining its account (typically, a set of an ID and a password). The account is associated with one of investor wallets, which are provided for each investor. The investor wallets are used to reserve investors' own money, project tokens, dividends and the like.

(6) Deciding to Make Investment

When one of the investors 30 has decided to make investment on one of the projects, the investor 30 accesses the service site and input information of the project to make investment on and the amount of money to invest.

(7) Depositing Investment Money

The investor 30, having decided to make investment on one of the project, deposits investment money in its investor wallet. The service administrator 10 transfers the deposited investment money to an investment money pool account and the deposited investment money is added to the money deposited in the investment money pool account. The investment money of each project is accumulated in one investment money pool account.

(8) Issuing Project Token

The service administrator 10 issues project tokens in a number corresponding to the amount of investment money invested by the investor 30 and the investor 30 obtains the project tokens. The project tokens are reserved in the investor wallet of the investor 30. The project token can be regarded as pseudo securities issued for each project, which can be exchanged in markets. The project token is initially issued at a fixed price but the price may afterwards fluctuate according to markets.

(9) Issuing Advertisement Token

The project gets established on condition that the amount of money reserved in the investment money pool account is not less than the minimum amount of investment money prescribed in the investment conditions when the period for inviting investments ends. Once the project is established, the service administrator 10 issues advertisement tokens in a number corresponding to the total amount of investment money reserved in the investment money pool account and the application software provider 20 obtains the advertisement tokens. The advertisement tokens are reserved in the advertisement token wallet of the application software provider 20. The application software provider 20 is allowed use the obtained advertisement tokens to finance its advertisement expenses. In other words, the application software provider 20 has obtained a right to place advertisements using the advertisement tokens instead of investment money.

(10) Advertisement Agencies Registering on Service Site

In the system, it is preferable that the application software provider 20 is allowed to select one or more of the advertisement agencies 40 through which to place advertisements. This enables the advertisement agencies 40 to take advertisement orders efficiently. An advertisement agency 40 (actually, the terminal of the advertisement agency) who uses the system for the first time is required to register its unique information in the service site, thereby obtaining its account (typically, a set of an ID and a password).

(11) Launching Sub-Project

The application software provider 20 intending to place advertisements through the advertisement agencies using the investment money launches one or more sub-projects for the purpose of inviting advertisement agencies. (The project for raising investments is regarded as a master project, and projects deriving from the master project as sub-projects.) A sub-project is launched for one time advertisement publishing. The term “one time advertisement publishing” herein refers to an act of exposing an advertisement for a certain period of time. In order to implement multiple times of advertisement publishing, multiple sub-projects must be launched. The application software provider 20 can invite different advertisement agencies for different sub-projects.

A sub-project is allocated with advertisement fee in the amount obtained by dividing the total amount of investment money by the total number of sub-projects. Alternatively, the application software provider 20 may be allowed to arbitrarily divide and allocate the investment money. In the latter case, the investment money may be divided evenly or unevenly, or the investment money may be allocated to only one sub-projects if the total amount of investment money is small.

The application software provider 20 launches sub-projects by registering in the service site information of the sub-projects including the number of sub-projects, the amount of investment money to be allocated thereto and the like. The service administrator 10 stores the received sub-project information in the database and makes it possible for the advertisement agencies 40 to browse the information.

(12) Applying for Sub-Project

The advertisement agencies 40 browse the sub-project information listed in the service site and apply for sub-projects they wish to take on. The application software provider 20 is allowed to browse applications for the sub-projects by the advertisement agencies 40 in the service site. The application software provider 20 selects one advertisement agency to be their agent for each sub-project. The application software provider 20 can also request all of part of the applying advertisement agencies 40 for cost estimation. The application software provider 20 is allowed to negotiate with the applying advertisement agencies 40 via the service site.

(13) Deciding Advertisement Expenses

The application software provider 20 decides through which advertisement agency 40 to place advertisements in connection with each of the sub-projects and the advertisement expense therefore. Multiple sub-projects may be taken on by the same advertisement agency 40. The service administrator 10 stores information of the decided advertisement agencies 40 and advertisement expenses as part of the sub-project information.

In case the application software provider 20 does not use the advertisement agencies, the application software provider 20 informs the service administrator 10 of the advertisement expenses which it decided to pay to the advertisement publishers. The service administrator 10 stores this information.

(14) Publishing Advertisements

The application software provider 20 may decide the content and publication periods of the advertisements and tell it to the advertisement agencies 40, or may leave these matters to the advertisement agencies 40. The advertisement agencies 40 arrange advertisement publishers who take on publishing advertisements.

In case the application software provider 20 does not use the advertisement agencies, the application software provider 20 deals directly orders the advertisement publishers to publish the advertisements.

(15) Reporting Advertisement Effects

When the publishing of the advertisements is done, the advertisement agencies 40 advertisement agencies 40 sends the information of advertisement effects to the service administrator 10.

(16) Browsing Advertisement Effects

The application software provider 20 is allowed to browse the advertisement effect information in the service site.

(17a)(17b) Payment of Advertisement Fee

The service administrator 10, upon receipt of the advertisement effect information, transfers the predetermined amount of money as advertisement fees from the investment money pool account to the advertisement agencies 40 or the advertisement publishers, directly without going through the application software provider 20. The advertisement fees include the fees of the advertisement agencies 40.

The service administrator 10 deducts the advertisement tokens in the advertisement token wallet of the application software provider 20 in a number corresponding to the amount of money transferred as the advertisement fees. Thus, advertisement tokens are consumed as the advertisement fees are paid.

(18) Paying to Service Administrator

When the advertisement fees are paid from the investment money pool account, the service administrator 10 may also receive payment of its fee.

(19) Sales Proceeds of Application Software

After the advertisements are published, the application software provider 20 gains sales proceeds through the monetization function of the application software. Sales proceeds gained before publishing advertisements is not processed in the system.

(20) Depositing Sales Distribution Money

The application software provider 20 deposits part of the sales proceeds as sales distribution money in the dividend account of the service administrator 10 at predetermined times. The ratio of the sales distribution money to the sales proceeds is prescribed as the sales distribution conditions in the project information.

(21) Paying Dividend

Dividends are paid from the dividend account to the investor wallets at predetermined times.

As shown in FIG. 2, the system starts sales distribution upon publishing advertisements. The advertisement publication lasts for a predetermined period. Although not shown in the figures, advertisement publication may be made more than one times. When a predetermined period lapses after the end of advertisement publication, the project is completed. In this example, sales distribution ends on the date the project is completed. Alternatively, the end of sales distribution may not be set. In this case, sales distribution is carried out when necessary.

In FIG. 2, two ways of sales distribution are exemplified. In example 1, sales distribution is carried out on the basis of the same distribution ratio 1 throughout the distribution period. In example 2, sales distribution is carried out on the basis of a distribution ratio 1 before the investment money is collected, and on the basis of a distribution ratio 2 after the investment money is collected. A distribution period is set for sales distribution based on the distribution ratio 2. In other words, sales distribution based on the distribution ratio 2 ends when the distribution period lapses. Ways of sales distribution are not limited to the above-described examples. In principle, the amount of the distributed money is proportional to the number of the project tokens each investor retains.

In case of a non-profit application software, sales distribution is carried out since it does not make sales proceeds. The investors investing on a non-profit application software do not obtain dividends in proportion to the number of the project tokens they retain. Even a non-profit application software can motivate the investors to make investment on it if it is an interesting or popular application software. Since the project tokens are exchangeable in markets as mentioned in the above, the investors may gain profits by selling the project tokens, if not obtaining dividends.

<System Configuration>

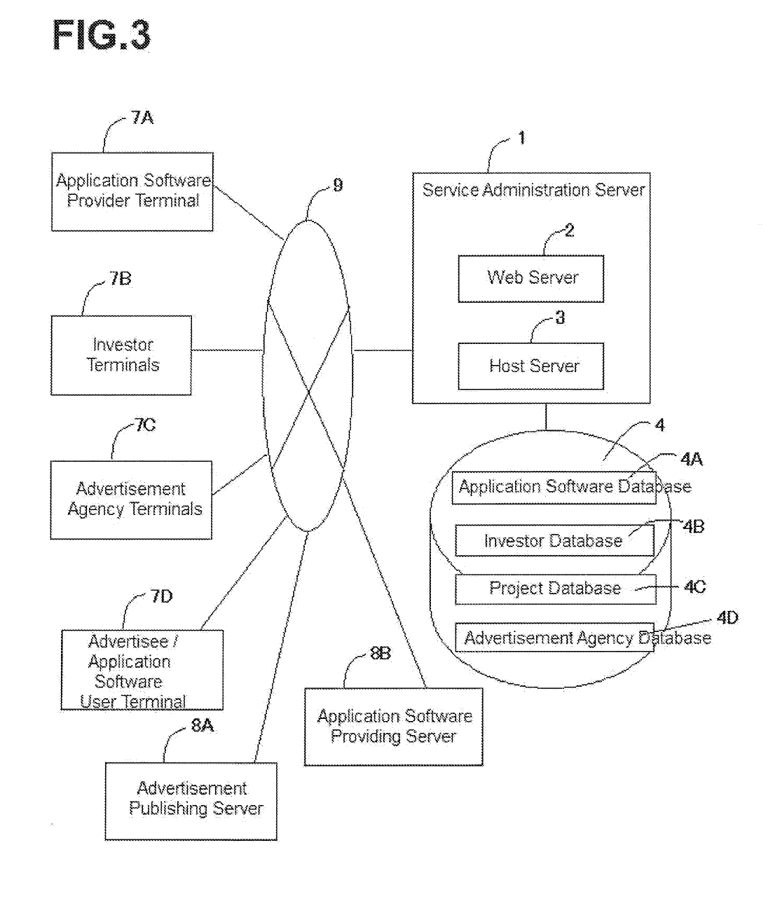

FIG. 3 is a view schematically showing an exemplary configuration of the overall network system including the system of the present invention, which turns the above-mentioned business model into reality. The service administrator shown in FIG. 1 manages a service administration server 1. The service administration server comprises a web server 2 and a host server 3 cooperate with one another. These servers are substantially server programs and the CPUs of the server computers implement programs read in memories so as to realize the functions of the service site and the service administrator shown in FIG. 1. Accordingly, it can be said that the web server 2 and the host server 3 are substantially computers functioning as a web server machine and a host server machine.

The web server 2 provides the service site shown in FIG. 1 by performing data communication with web browser terminals via a network 9, which is typically the Internet. The host server 3 processes registration of the application software provider, investors and advertisement agencies, projects and sub-projects shown in FIG. 1. The host server 3 also processes transference, change and/or issuance of investment money, sales distribution money, dividends and tokens. The web server 2 and the host server 3 cooperate with one another. The service administration server 1 cooperates with a database 4.

The database 4 is constructed on storage devices such as hard disks. The database 4 comprises an application software database 4A storing information regarding the application software provider, a project database 4B storing information regarding the projects, an investor database 4C storing information regarding the investors and an advertisement agency database 4D storing information regarding the advertisement agencies. The examples of the tables stored these databases will be shown below although the construction of these databases are not limited to the shown examples.

There is also provided an application software provider terminal 7A, investor terminals 7B and advertisement agency terminals 7C which are browser terminals which communicate information through the web server 2 via the network. These terminals are typically smartphones, tablet computers, personal computers, etc. having communication function.

There are also provided advertisement publishing servers 8A which are managed by the advertisement publishers. Upon receipt of orders of advertisement from the advertisement agencies or the application software provider, the advertisement publishing servers 8A publish various modes of advertisements via the network 9.

There is also provided an application software providing server 8B which provides the application software via the network 9.

There are also provided advertisee/application software user terminals 7D which allow their users to view the published advertisements provided by the advertisement publishing servers 8A, to view the information of the application software related to the advertisements provided by the application software providing server 8B and to download the application software. By downloading the application software, the users of the advertisee/application software user terminals 7D are charged through the charging points of the application software, thereby generating sales proceeds for the application software provider.

<Host Server Configuration>

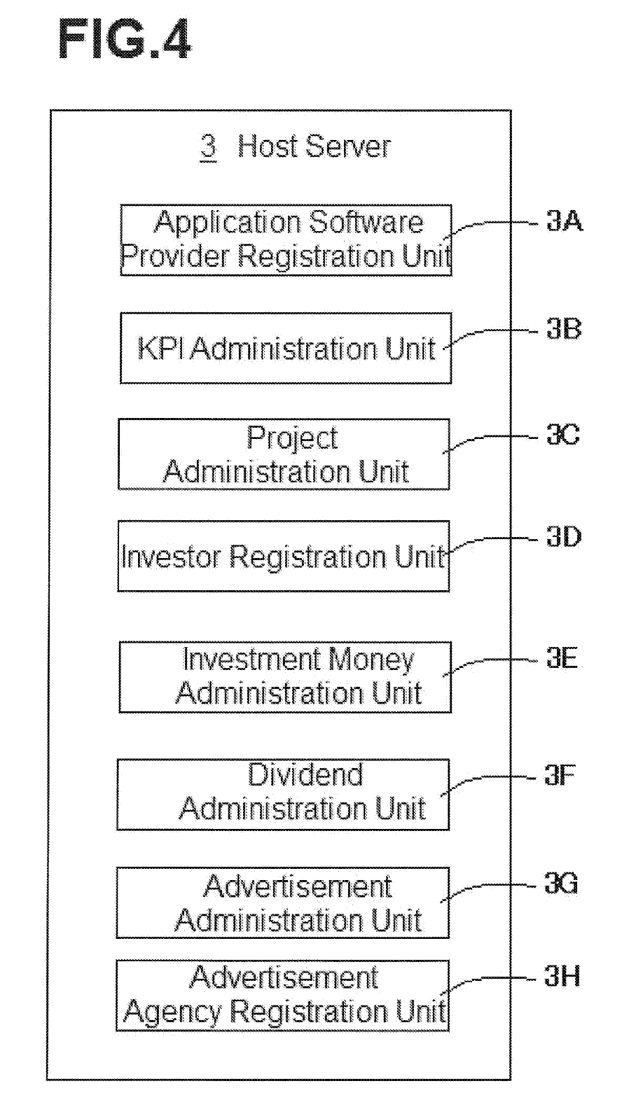

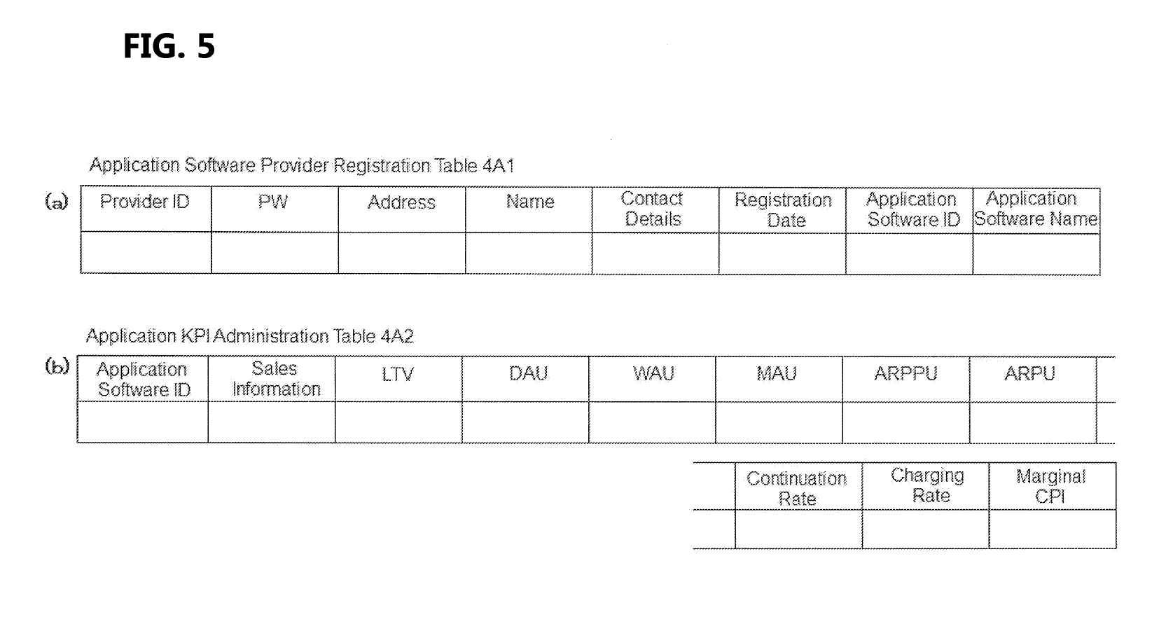

FIG. 4 is a schematic block diagram showing the major functions of the host server shown in FIG. 3. The host server 3 comprises, as its main functions, an application software provider registration unit 3A, a KPI administration unit 3B, a project administration unit 3C, an investor registration unit 3D, an investment money administration unit 3E, a dividend administration unit 3F, an advertisement administration unit 3G and an advertisement agency registration unit 3H. The configuration shown in FIG. 4 is only an example. Hereinafter, the functions of these units are described. (the configuration of the tables in the databases 4A, 4B, 4C and 4D will be described with reference to FIGS. 5 to 8.)

In FIG. 4, the application software provider registration unit 3A receives from the application software provider terminal attribute information of the application software provider and registers it. The application software provider registration unit 3A provides the application software provider with an ID and a password, which is related to its attribute information and stored in an application software provider registration table 4A1 shown in FIG. 4.

In FIG. 4, the KPI administration unit 3B, after the SDKs are installed in the charging points of the application software, accumulates sales information received from the application software, which is data of charging performance. The KPI administration unit 3B generates KPI information based on the statistical data and/or analytical data of a predetermined period (e.g. a day, a week, a month, etc.) worked out using the accumulated sales information. The KPI administration unit 3B stores the sales data and the KPI information in an application KPI administration table 4A2, which is updated periodically, or preferably in real time.

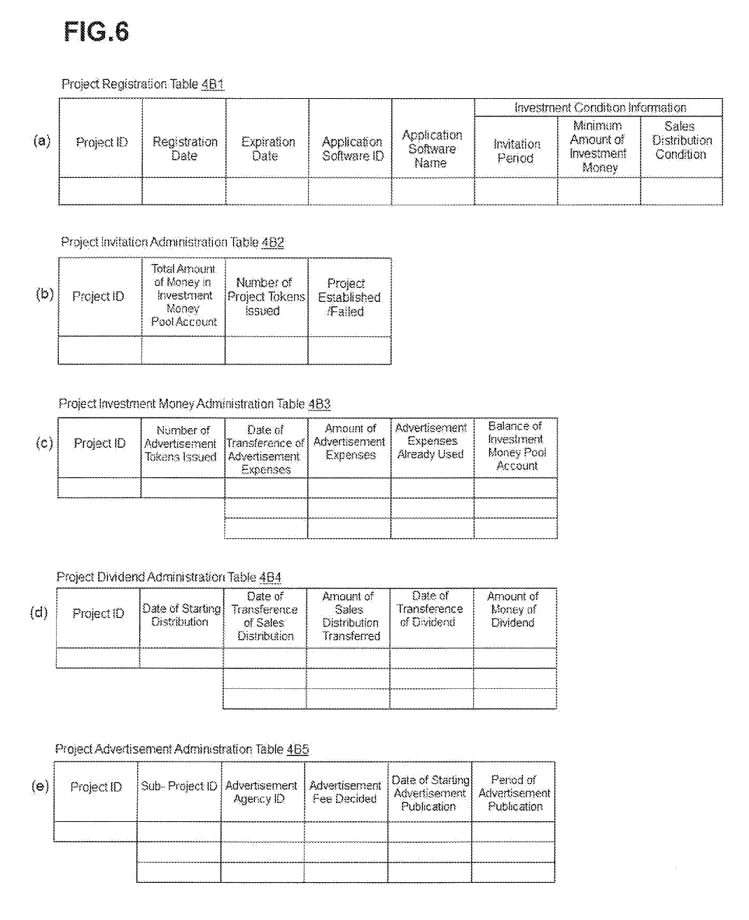

In FIG. 4, the project administration unit 3C receives from the application software provider terminal 7A new project information and registers it. The new project information is stored in a project registration table 4B1 shown in FIG. 6(a).

Furthermore, the project administration unit 3C administrates the investment money stored in the investment money pool account during the period from the establishment to the end of invitation of the projects and the project tokens issued in connection with the projects. The records of the stored investment money and the issued project tokens are stored in a project invitation administration table 4B2 shown in FIG. 6(b).

Furthermore, the project administration unit 3C administrates the advertisement tokens issued during the period from establishment to end of invitation of the projects and the investment money transferred as the advertisement expenses during the period from the end of invitation of the projects to the end of the projects. The records of transference of the investment money is stored in a project investment money administration table 4B3 shown in FIG. 6(c).

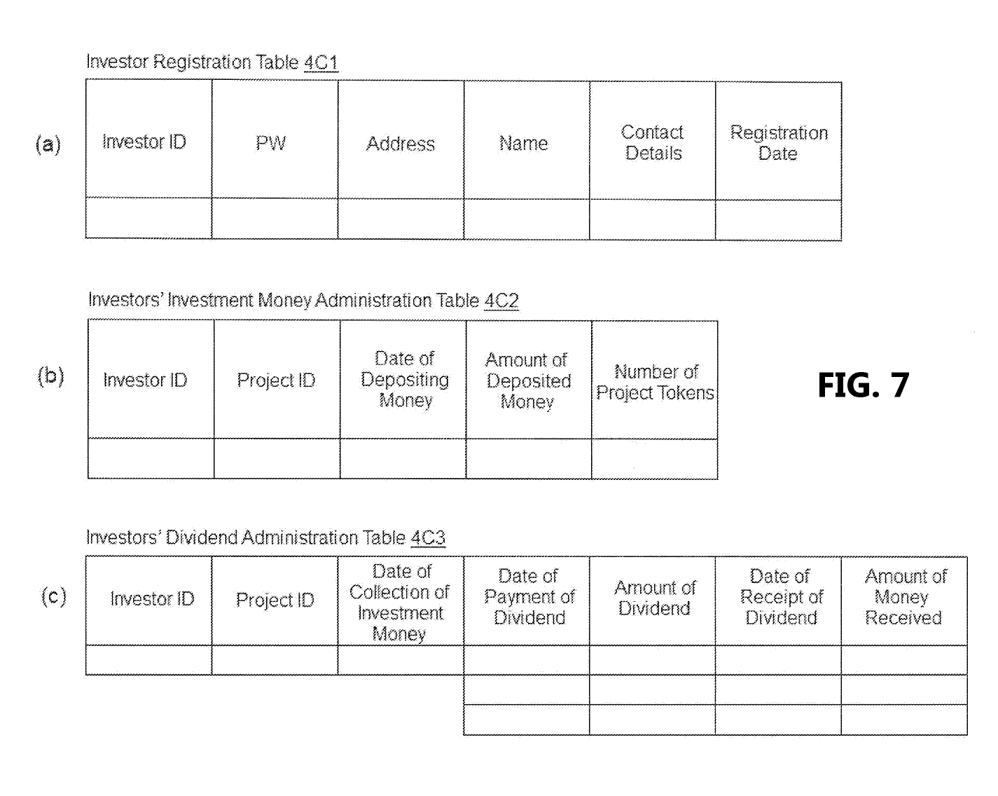

In FIG. 4, the investor registration unit 3D receives from the investor terminals attribute information of the investors and registers it. The investor registration unit 3D provides each investor with an ID and a password, which is related to its attribute information and stored in an investor registration table 4C1 shown in FIG. 7(a).

In FIG. 4, the investment money administration unit 3E administrates investment money of each investor. This function corresponds to that of administrating the investment money and the project tokens in the investor wallets as shown in FIG. 1. The investment money administration unit 3E stores and updates information in an investors' investment money administration table 4C2 shown in FIG. 7(b).

In FIG. 4, the dividend administration unit 3F administrates transference of the sales distribution money from the application software provider and of dividends to the investors. This function corresponds to that of administrating transference of money in the dividend account as shown in FIG. 1. The dividend administration unit 3F stores and updates information in a project dividend administration table 4B4 in FIG. 6(d) and an investors' dividend administration table 4C3 in FIG. 7(c).

Furthermore, the dividend administration unit 3F, upon receiving request from the investor terminals, calculates the amount of the expected dividends and allows the investor terminals to browse it. The amount of the expected dividends is calculated on the basis of the KPI information and the sales distribution conditions. Preferably, The amount of the expected dividends is calculated and shown in real time.

In FIG. 4, the advertisement administration unit 3G administrates information regarding publication of advertisements in connection with the application software, such as information of the sub-projects inviting the advertisement agencies. The information of the decided advertisement agencies, advertisement fees/expenses, publication terms, etc. can be obtained from the application software provider terminal or advertisement agency terminals through the service site. The advertisement administration unit 3G stores and updates information in a project advertisement administration table 4B5 shown in FIG. 6(e).

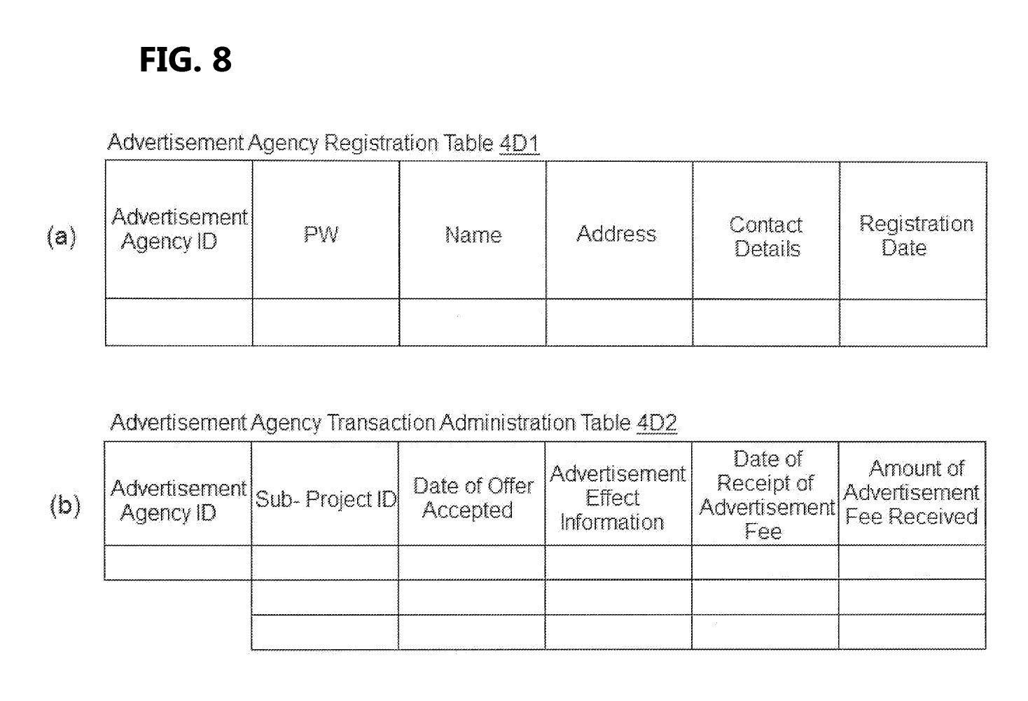

In FIG. 4, the advertisement agency registration unit 3H receives from the advertisement agency terminals attribute information of the advertisement agencies and registers it. The advertisement agency registration unit 3H provides each advertisement agency with an ID and a password, which is related to its attribute information and stored in an advertisement agency registration table 4D1 shown in FIG. 8(a). The advertisement agency registration unit 3H also stores transaction records of the advertisement agencies taking on the sub-projects in an advertisement agency transaction administration table 4D2 shown in FIG. 8(b).

<Database Configuration>

FIG. 5 is a view showing examples of the tables stored in the application software database 4A shown in FIG. 3.

In FIG. 5(a), the application software provider registration table 4A1 generates a new record when an application software provider is registered. The application software provider registration table 4A1 has such data items as provider ID, password, address, name, contact details, registration date and the like.

The application software provider registration table 4A1 also has data items regarding the application software such as application software ID and application software name. Although not shown in the figures, it may also have other data items regarding the application software such as web page URL, distribution area, distribution type (web application software or native application software, etc.), charging type (monthly charging, charging per download, meter rate charging, setting charging points, etc.). A newly registered application software is provided with an application software ID. One application software provider may register more than one application softwares.

In FIG. 5B, the application KPI administration table 4A2 has such data items as application software ID, sales information, LTV (Life Time Value), DAU (Daily Active Users), WAU (Weekly Active Users), MAU (Monthly Active Users), ARPPU (Average Rate Per Paid User), ARPU (Average Rate Per User), continuation rate, charging rate, marginal CPI and the like. The sales information received from the SDKs of the application software is accumulated daily and a new KPI information is generated base on the updated sales information.

FIG. 6 is a view showing examples of the tables stored in the project database 4B shown in FIG. 3.

In FIG. 6(a), the project registration table 4B1 generates a new record when a new project is registered. The project registration table 4B1 has such data items as project ID, registration date, expiration date, application software ID, application software name and the like.

The application software provider registers a new project on predetermined investment conditions. The investment conditions are stored in the project registration table 4B1 which also has such data items as invitation period, minimum amount of investment money, sales distribution condition and the like.

A minimum amount of investment money sets a lower limit of the amount of money that needs to be stored in the investment money pool account in order fora project to established. The project registration table 4B1 may also have such data items as maximum amount of investment money which sets an upper limit of the amount of money in the investment money pool account can store and maximum amount of investment money per investor and the like. Once a maximum amount of investment money is decided for a project, the maximum number of project tokes issuable in the project is decided accordingly.

The data item sales distribution condition further includes such data items as sales distribution ratio, date of starting distribution and the like. The sales distribution ratio sets a ratio of sales proceeds distributed as dividends. The sales distribution ratio may be set in different ways as shown in FIG. 2. The date of starting distribution may be the same date as that of starting advertisement publication.

In FIG. 6(b), the project invitation administration table 4B2 is used for administration purpose during invitation period of project. The project invitation administration table 4B2 has such data items as project ID, total amount of money in investment money pool account, number of project tokens issued, project established/failed and the like. The total amount of money in investment money pool account increases upon receiving investment money from new investors. The number of project tokens issued increases upon issuance of project tokens in conjunction with deposition of the newly invested money. Whether a project is established or failed is decided based on whether the amount of money reserved in the investment money pool account is not less than the minimum amount of investment money prescribed in the investment conditions.

In FIG. 6(c), the project investment money administration table 4B3 is used for recording the number of advertisement tokens issued to the application software provider at the time of establishing a project, transference of money used as advertisement expenses from the investment money pool account and handling deduction of advertisement tokens relating to the transference of money. The project investment money administration table 4B3 has such data items as project ID, number of advertisement tokens issued, date of transference of advertisement expenses, amount of advertisement expenses, advertisement tokens already used, balance of investment money pool account and the like. In case more than one sub-projects are established and more than one advertisements are published, transference of money used as advertisement expenses is implemented more than one times.

In FIG. 6(d), the project dividend administration table 4B4 is used for administrating transference of sales distribution money into the dividend account and of dividends from the dividend account. The project dividend administration table 4B4 has such data items as project ID, date of starting distribution, date of transference of sales distribution, amount of sales distribution transferred, date of transference of dividend, amount of money of dividend and the like. Typically, the transference of sales distribution money and of dividends are implemented more than one times respectively.

In FIG. 6(e), the project advertisement administration table 4B5 is used for registering information regarding advertisement publication. The advertisement administration table 4B5 has such data items as project ID, sub-project ID, advertisement agency ID, advertisement fee decided, date of starting advertisement publication, period of advertisement publication and the like.

Publication of advertisements is implemented more than one times. Preferably, one sub-project is established for one publication of advertisement to invite the advertisement agencies and each sub-project is provided with a sub-project ID, which is registered in the project advertisement administration table 4B5. When the advertisement agency to order and the advertisement fee are decided, the project advertisement administration table 4B5 stores the ID of the advertisement agency and the decided advertisement expenses. The amount of advertisement expenses stored in the project investment money administration table 4B3 corresponds to the advertisement fee decided in the project advertisement administration table 4B5.

FIG. 7 is a view showing examples of the tables stored in the investor database 4C shown in FIG. 3.

In FIG. 7 (a), the investor registration table 4C1 generates a new record when a new investor is registered. The investor registration table 4C1 has such data items as investor ID, password, address, name, contact details, registration date and the like.

In FIG. 7(b), the investors' investment money administration table 4C2 is used for administrating the investors' investment money after the investment money is deposited in connection with the projects the investors decided to invest on. The investors' investment money administration table 4C2 has such data items as investor ID, project ID, date of depositing money, amount of deposited money, number of project tokens and the like. One investor may invest on more than one projects.

In FIG. 7(c), the investors' dividend administration table 4C3 is used for administrating the investors' dividends. The investors' dividend administration table 4C3 has such data items as investor ID, project ID, date of collection of investment money, date of payment of dividend, amount of dividend, date of receipt of dividend, amount of money received and the like. The date of collection of investment money sets the date an investor has collected its capital invested. From this date on, the sales distribution ratio may be changed. The date of payment of dividend sets the date a dividend is transferred from a dividend wallet to an investor wallet. The date of receipt of dividend sets the date a dividend is transferred out from an investor wallet.

FIG. 8 is a view showing examples of the tables stored in the advertisement agency database 4D shown in FIG. 3.

In FIG. 8(a), the advertisement agency registration table 4D1 generates a new record when anew advertisement agency is registered. The advertisement agency registration table 4D1 has such data items as advertisement agency ID, password, name, address, contact details, registration date and the like.

In FIG. 8(b), the advertisement agency transaction administration table 4D2 is used for administrating the records of transaction by the advertisement agencies taking on the sub-projects and receiving payment of the advertisement fee. The advertisement agency transaction administration table 4D2 has such data items as advertisement agency ID, sub-project ID, date of offer accepted, advertisement effect information, date of receipt of advertisement fee, amount of advertisement fee received and the like. The date of offer accepted sets a date on which order of a sub-project and its advertisement fee are decided. The advertisement effect information stores information received after advertisement publication is completed. The date of receipt of advertisement fee sets a date on which advertisement fee is transferred from the investment money pool account to the advertisement agencies. The amount of advertisement fee received corresponds to the amount of advertisement expenses in the project investment money administration table 4B3 and the advertisement fee decided in the project advertisement administration table 4B5.

<Process Flow of Registering Project and Raising Investments>

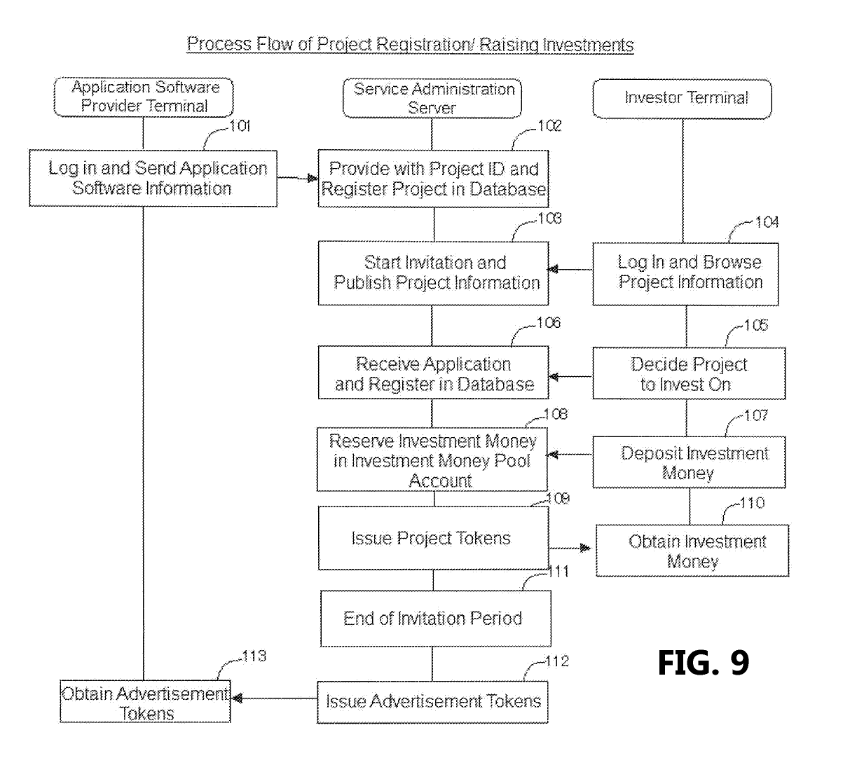

FIG. 9 is a view showing an example of the process flow of registering a project and raising investments in the system of the present invention. At this stage, registration of the application software provider and the investors have been completed (see FIG. 5 (a) and FIG. 7(a)) and the application software is already installed with the SDKs and is capable of generating KPIs.

Step 101:

The application software provider, using the application software provider terminal, logs in the service site of the service administration server. On a display screen of selecting functions, the application software provider selects to register a project. The application software provider sends information of the project to the service administration server. The project information includes information of the application software and investment conditions.

The investment conditions include invitation period, minimum amount of investment money, maximum amount of investment money, sales distribution condition, date of end of a project. The invitation period sets dates of starting and ending of invitation. The sales distribution condition sets a sales distribution ratio with which to divide sales proceeds between the application software provider and the investors. The money distributed to each of the investors out of the sales proceeds is a dividend.

Step 102:

The service administration server accepts registration of a new project and provides the project with a project ID, which is stored in the project database (see FIG. 6(a)).

It is preferable that information regarding advertisement publication is registered at the same time as the project is registered (see FIG. 6(e)). Since the project is not established yet at this stage, the information regarding advertisement publication is an expected one, particularly regarding such data items as number of times advertisements are published, date of starting advertisement publication and date of ending advertisement publication.

The date of starting advertisement publication is preferably the same as the date of starting distribution since investments are made in expectation of increase in sales proceeds by advertisement publication. The date of ending the project is preferably set at a timing after a predetermined time has passed from the date of ending advertisement publication.

Step 103:

On the date of starting advertisement publication, the project is established. The project information is published on the service site, which can be accessed via the network. The project information includes the KPI information as well as the application software information and the investment conditions. Preferably, the KPI information is updated daily.

Step 104:

The investors, using their investor terminals, log in the service site, browse the project information and considers which project to invest on taking the KPI information into account. The KPI information is shown in the form of a graphical representation, which is easy to understand regardless the language it uses.

Step 105:

Having decided which project to invest on, the investors using their investor terminals, log in the service site and apply for the project. At this stage, the investors decide the amount of investment money.

Step 106:

The service administration server receives the applications for the project from the investor terminals and stores the information in the investor database (see FIG. 7 (b))

Step 107:

The investors deposit the investment money on or shortly after applying for the project. It is preferable that the investors deposit the investment money in a virtual currency which is realized by block chain technologies. The deposited investment money is reserved in the investor wallets (see FIG. 1).

It is preferable that the investors is allowed to choose from several kinds of virtual currencies, e.g. etherium, bit coin, etc. which they use as investment money. In stead of virtual currencies, real currencies may be used such as U.S. dollar and Japanese yen.

Step 108:

The service administration server transfers the investment money deposited in the investor wallets to the investment money pool account (see FIG. 1). Thus, the investment money pool account reserves the investment money from multiple investors. The service administration server administrates the investment money reserved in the investment money pool account (see FIG. 6 (b)).

Alternatively, the investors may deposit some amount of money in the investor wallets and the service administration server transfers designated amount of money from the investor wallets to the investment money pool account.

Step 109:

The service administration server issues to each investor project tokens in a number corresponding to the amount of investment money it invested. The number the project tokens obtained by each investor is recorded in the investor database (see FIG. 7(b)). The total number of the project tokens issued is recorded in the project database (see FIG. 6(b)).

Step 110:

The project tokens obtained by the investors are reserved in the investor wallets of the service administration server. The project token can be regarded as pseudo securities issued for each project, which is initially issued at a fixed price, but the price may afterwards fluctuate according to the status of the project.

The project tokens can be exchanged in markets (for example, among the investors). It is preferable that the project tokens are exchanged using block chain technologies. When the investors sell their project tokens (for example, to other investors), the information in the investor database is updated accordingly. When the investors buy project tokens (for example, from other investors) and deposit it in the investor wallets, the information in the investor database is updated accordingly. In principle, the investors obtains dividends in the amount corresponding to the amount of the project tokens reserved in the investor wallets at the time of distribution.

Step 111:

During the invitation period, in a desirable case, investment money from many investors is collected and accumulated in the investment money pool account until the invitation period ends. The project is established on condition that the total amount of investment money reserved in the investment money pool account is not less than the minimum amount of investment money prescribed in the investment conditions when the invitation period ends. In case the total amount of investment money reserved in the investment money pool account is less than the minimum amount of investment money prescribed in the investment conditions, the project fails to be established and the investment money reserved in the investment money pool account is returned to the investor wallets.

Step 112:

When the project is established in step 111, the advertisement tokens are issued to the application software provider. The number of the advertisement tokens issued is decided based on the total amount of investment money reserved in the investment money pool account. It is preferable that the advertisement tokens are issued using block chain technologies, which secures the transactions.

Step 113:

The issued advertisement tokens are reserved in the advertisement token wallet of the application software provider made in the service administration server. The application software provider is allowed to use the advertisement tokens for advertisement expenses. The number of the advertisement tokens is deduced when the advertisement tokens are used and the transaction records are stored in the project database (see FIG. 6(c)).

The application software provider obtains aright to place advertisements using the advertisement tokens but is not allowed to use the investment money reserved in the investment money pool account. In other words, not the investment money but only the advertisement tokens are given to the application software provider. The application software provider is not allowed to transfer the investment money reserved in the investment money pool account either.

<Process Flow of Publishing Advertisements and Paying Advertisement Fees>

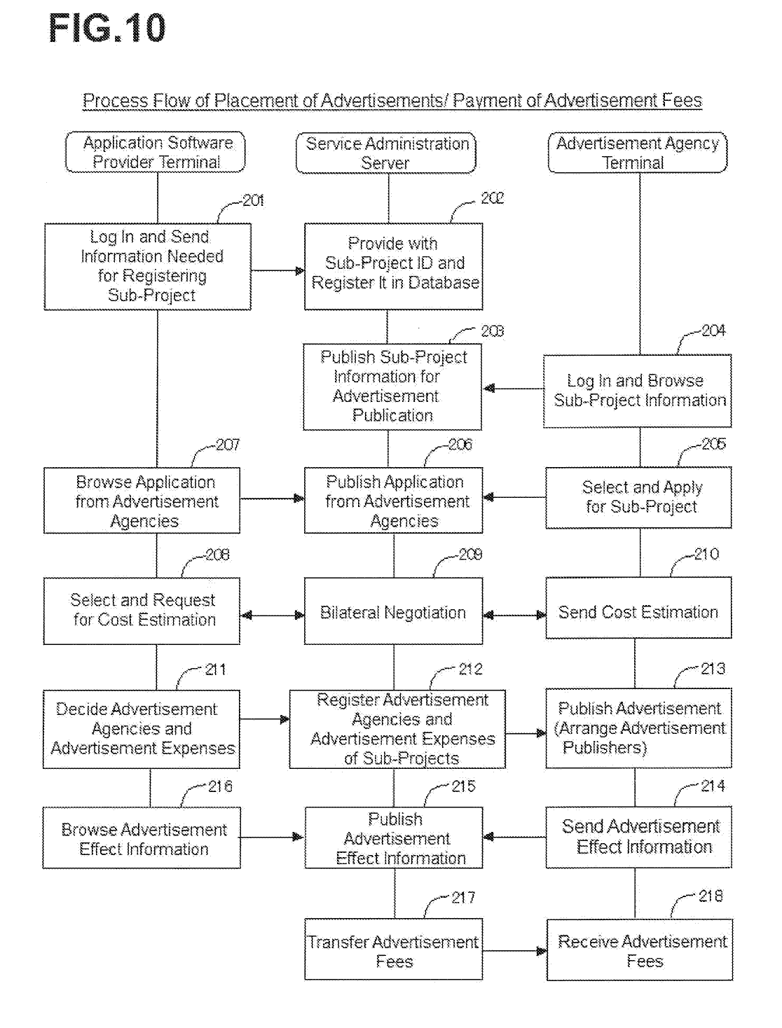

FIG. 10 is a view showing an example of the process flow of placing advertisements and paying advertisement fees in the system of the present invention. In this example, the application software provider places advertisements using the advertisement agencies. At this stage, the application software provider the project has been established and all the investment money is reserved in the investment money pool account and advertisement agencies have been registered in the advertisement agency registration table (see FIG. 8(a)).

Step 201:

The application software provider, using the application software provider terminal, logs in the service site of the service administration server. On a display screen of selecting functions, the application software provider selects to register sub-projects. The application software provider sends information of the sub-projects to the service administration server, thereby the sub-projects for advertisement publication are established.

The sub-project information includes at least the number of sub-projects and the amount of advertisement expense allocated to each sub-project. The number of sub-projects is decided on the basis of the number of times the application software provider desires to publish advertisement. The application software provider divides the total investment money by the number of sub-projects and allocate advertisement expense to each sub-project. The advertisement expense may be allocated to each sub-project evenly or unevenly. In case a total investment money of 10,000,000 yen is used to publish advertisement 4 times, for example, the four sub-projects may be allocated with 3,000,000 yen, 3,000,000 yen, 3,000,000 yen and 1,000,000 yen, respectively.

In case the number of sub-project is one, the investment money need not be divided and all the investment money is allocated to the sub-project.

The application software provider add such information to the sub-project information as the content of advertisement, the date of starting advertisement publication, and/or period of advertisement publication. In case the content of advertisement is changed from the previous one, the related records are updated. Alternatively, the application software provider may not have to decide the content of advertisement and leave it to the advertisement agencies.

Step 202:

The service administration server, upon accepting registration of one or more sub-projects, provides each sub-project with a sub-project ID and stores it in the project database (see FIG. 6(e)).

Step 203:

The service administration server publishes the sub-project information on the service site and invites the advertisement agencies to take on the sub-projects.

Step 204:

The advertisement agencies, using the advertisement agency terminals, logs in the service site and browse the sub-project information. The advertisement agencies considers which sub-project to apply to taking into consideration mainly the advertisement expenses in the sub-project information. The advertisement agencies can also browse the project information corresponding to the sub-projects. Based on the project information, each advertisement agency can judge whether or not the project belongs to the advertisement fields which it can handle.

Step 205:

Having decided to apply for a sub-project, the advertisement agencies, using the advertisement agency terminals, logs in the service site and make applications. One advertisement agency can apply for more than one sub-projects.

Step 206:

The service administration server publishes the application states of the sub-projects on the service site and allow the advertisement agencies to browse it. One sub-project may be applied by more than one advertisement agencies.

Step 207:

The application software provider, using the application software provider terminal, logs in the service site and browses the application states of the sub-projects.

Steps 208, 209 and 210:

In case more than one advertisement agencies have applied for one sub-project, the application software provider may request all of part of the applying advertisement agencies for cost estimation. The advertisement agencies requested for cost estimation may offer estimated advertisement fees which are lower than the advertisement expenses allocated to the sub-projects with an aim of winning the competition. In this manner, the application software provider and the advertisement agencies can negotiate through the service site.

Alternatively, the application software provider may select for each of the sub-projects the advertisement agency to order without negotiating with the advertisement agencies.

Step 211:

The application software provider finally decides which advertisement agency to order and the advertisement expense for each sub-project.

Step 212:

The service administration server stores in the project database the advertisement agency to order and the advertisement expense which the application software provider has decided to order for each sub-project (see FIG. 6(e)).

Step 213:

The advertisement agencies having received orders for the sub-projects arranges advertisement publishers who take on publishing advertisements. The advertisement publishers publish advertisements in various modes. For example, advertisements can be published through the ad networks such as Facebook AD and Google AD.

Step 214:

The After completing publication of advertisements, the advertisement agencies logs in the service site and sends the advertisement effect information which is regarded as a report of completion of advertisement publication. The advertisement effect information includes, for example, information of advertisement publishers, CPAs (Cost Per Action) and the like.

Step 215:

The service administration server publishes the advertisement effect information and allows the application software provider to browse it.

Step 216:

The application software provider browses the advertisement effect information and confirm that the advertisement publication for each sub-project is completed.

Step 217:

After the advertisement publication is completed, the service administration server pays the predetermined amount of money as advertisement expenses from the investment money pool account to the advertisement agencies. In case the application software provider did not use the advertisement agencies, payment is made from the investment money pool account to the advertisement publishers. The fee for the service administrator may be paid at the same time as the advertisement fees are paid.

The service administration server updates the project database upon the transference of money from the investment money pool account (see FIG. 6(c)). Specifically, the number of advertisement tokens of the application software provider are deducted in the number corresponding to the advertisement fees paid. At the same time, the money reserved in the investment money pool account is deducted in the amount of the advertisement fees paid. Along with the above processing, the advertisement agency database is updated (see FIG. 8(b)).

Step 218:

The advertisement publishers of advertisement agencies receive payment of advertisement fees. The advertisement agencies deduce their fees from the received advertisement fees and pay the rest to the advertisement publishers.

The above steps 213 to 218 is implemented for each sub-projects. In principle, when all the advertisement publication is completed, all the investment money in the investment money pool account is consumed and all the advertisement tokens of the application software provider is consumed.

<Process Flow of Distributing Sales Proceeds>

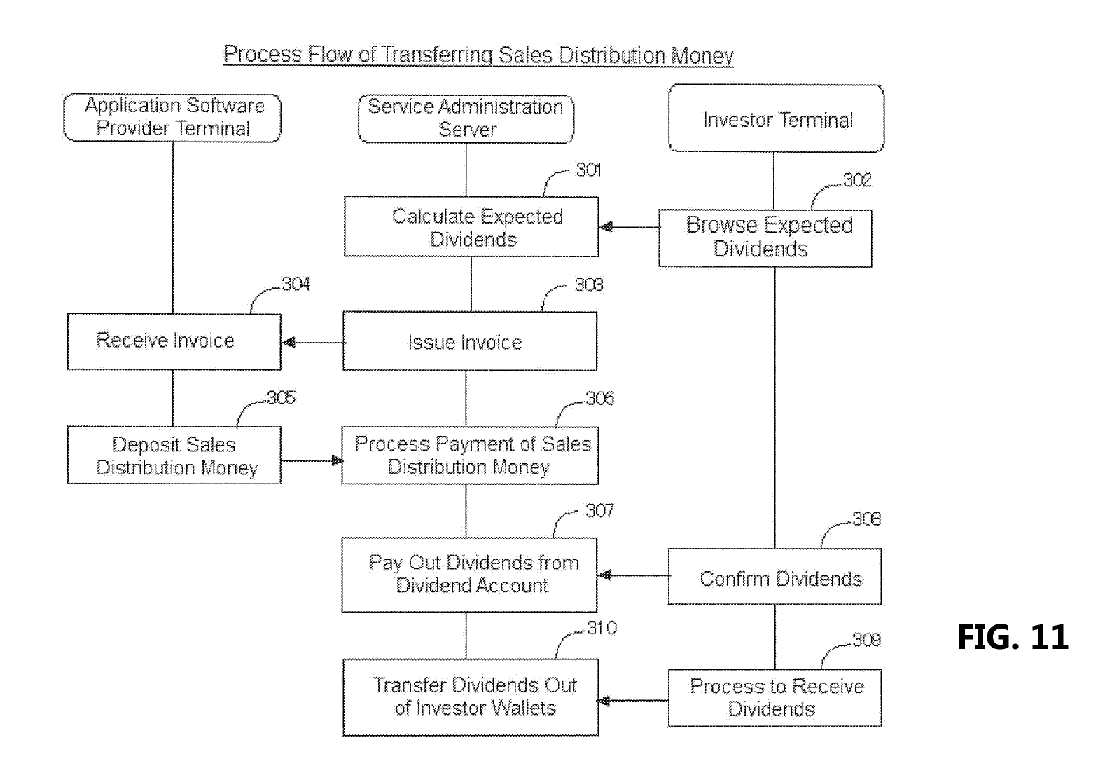

FIG. 11 is a view showing an example of the process flow of transferring sales distribution money. Since the investment in the system means that on advertisement expenses for the purpose of increasing sales proceeds, the sales distribution for the investors is funded by the sales proceeds gained after publishing advertisements. Accordingly, the date of starting distribution (see FIG. 6(c)) is set to be the same as the date starting advertisement publication.

The application software provider first obtains the sales proceeds of the application software. The application software provider is obliged to pay part of the sales proceeds to the service administrator as sales distribution money. The ratio of the sales distribution money to the sales proceeds is prescribed as the sales distribution conditions in the project information. The sales distribution money paid by the application software provider is used as dividends for the investors.

Step 301:

The service administration server calculates the amount of expected dividend for each investor in real time during the period the distribution is implemented. The amount of expected dividend for each investor is calculated on the basis of the sales information received in real time from the SDKs installed in the charging points of the application software, the ratio of the sales distribution money to the sales proceeds, the number of project tokens issued and the number of project tokens the investors retain according to the below formula:

Dividend=sales proceeds×sales distribution ratio×(number of project tokens he investors retain/number of project tokens issued)

Step 302:

The investors, using their investor terminals, log in the service site and browse the amount of expected dividends for themselves.

Step 303:

The service administrator issues invoices to the application software provider at predetermined timings (e.g. once a month). The amounts of sales distribution money to be indicated in the invoices are calculated according to the above formula.

Step 304:

The application software provider receives the invoices.

Step 305:

The application software provider pays the charged sales distribution money to the dividend account of the service administrator, preferably in virtual currencies.

Step 306:

The service administration server processes payment of the sales distribution money into the dividend account by updating the project database (see FIG. 6(d)).

Step 307:

The service administration server. Along with the above processing, the project database is updated (see FIG. 6 (d)). The dividends are transferred from the dividend account to the investor wallets. Along with the above processing, the investor database is updated (FIG. 7 (c)). The dividends are preferably paid in virtual currencies.

In case the dividend are transferred to the investor wallets in a virtual currency, it is preferable that the same kind of virtual currency is used as used in depositing the investment money in the investor wallets of the investors. In case the investment money has been deposited in the investor wallets in a real currency, it is preferable that the dividends are also transferred to the investor wallets in a real currency. Alternatively, the dividends may be transferred in a virtual or real currency which is designated by the service administrator.

Step 308:

After the dividends are transferred from the dividend account to the investor wallets, the investors, using their investor terminals, are allowed to confirm browses the dividends.

Step 309:

The investors may receive the dividends stored in the investor wallets at any time, i.e. transfer the dividends out of the system. The investors, using their investor terminals, login the service site and operates to transfer the desired amounts of dividends out of the system.

Step 310:

Along with the above operation by the investors, the service administration server transfers the designated amounts of dividends out of the system. In case the dividends are stored in virtual currencies, they can be transferred out of the system using block chain technologies. Then, the application software provider updates the investor wallets of the investor database (see FIG. 7(c)).

The investors may use the dividends reserved in their investor wallets as a new investment money for other projects.

The system configurations and the process flows of the public investment raising system for raising investments to fund advertisement expenses described in the above are merely examples and various changes may be made within the spirit of the present invention. Investments may be raised to fund activities other than advertisement. Also in that case, the investment money is directly paid to the payee without going through the application software provider. The application software providing business which raises investments using the system may be for-profit or non-profit.

Furthermore, the above-described process flow of placing advertisements and paying advertisement fees may be adopted not only in case the investment money is used for advertisement expenses but also in case the entrepreneurs or enterprises user their money to invite application from advertisement agencies.

### REFERENCE NUMERALS

1 service administration server
2 web server
3 host server
4A application software database
4B investor database
4C project database
4D advertisement agency database
7A application software provider terminal
7B investor terminals
7C advertisement agency terminals
7D advertisee/application software user terminal
8A advertisement publishing server
8B application software providing server
9 network
10 service administrator
20 application software provider
30 investors
40 advertisement agencies

1. A public investment raising system for raising investments to fund a business to provide an application software comprising:
an application software provider terminal for providing an application software;
at least one investor terminal for investing money to fund the business; and
a server connecting said application software provider terminal and said investor terminal via a network; wherein
said server comprises;
a means to register on a database application information regarding an application software received from said application software provider terminal,
a means to register on a database project information regarding a project of raising investments to fund a business to provide said application software, which includes investment conditions, received from said application software provider terminal,
a means to allow said investor terminal to browse said project information registered in the database via the network,
a means to store the money invested on said project by the investors in an investment money pool account made for said project in the database,
a means to issue to the application software provider activity tokens in a number corresponding to the total amount of investment money stored in said investment money pool account when the project satisfies said investment conditions become effected and to memorize the number of issued activity tokens in the database,
a means to transfer from said investment money pool account to a predetermined payee money to be used for the business to provide the application software, and
a means to deduct the activity tokens memorized in the database in a number corresponding to the amount of the transferred money.

2. The public investment raising system for raising investments to fund a business as set forth in claim 1, said server further comprising;
a means to issue to the investors project tokens in a number corresponding to the amount of money each investor has invested and to memorize the number of issued project tokens in the database.

3. The public investment raising system for raising investments to fund a business as set forth in claim 1, said server further comprising;
a means to send to said application software provider terminal SDKs to be incorporated in said application software, which has been registered in said server, for the purpose of retrieving performance information of said application software,
a means to retrieve the performance information of said application software from said SDKs incorporated in said application software,
a means to generate a KPI information based on the retrieved performance information, and
a means to allow said investor terminal to browse said KPI information.

4. The public investment raising system for raising investments to fund a business as set forth in claim 3, said server further comprising;
in case said application software comprises a monetization function, said performance information is that of sales proceeds and said SDKs are incorporated in the monetization function of said application software,
a means to retrieve information of the sales proceeds from said SDKs and to generate KPI information based on the retrieved information of the ales proceeds.

5. The public investment raising system for raising investments to fund a business as set forth in claim 4, said server further comprising;
a means to transfer sales distribution money, which is part of the sales proceeds of said application software, paid by said application software provider into a dividend account made for said project in the database, and
a means to make payment of dividends pooled in said dividend account to the investors.

6. The public investment raising system for raising investments to fund a business as set forth in claim 5, said server further comprising;
a means to issue to the investors project tokens in a number corresponding to the amount of money each investor has invested and to memorize the number of issued project tokens in the database,
said dividends being decided on the basis of the numbers of project tokens owned by the investors.

7. The public investment raising system for raising investments to fund a business as set forth in claim 5, said server further comprising;
a means to calculate expected dividends on the basis of the amount of said sales distribution money, the number of project tokens owned by each investor and the total number of issued project tokens, and
a means to allow said investor terminal to browse the calculated expected dividends via the network.

8. The public investment raising system for raising investments to fund a business as set forth in claim 5, wherein
said means to store the money invested on said project by the investors in said investment money pool account transfers investment money from investor wallets made in the database to said investment money pool account, and
said means to make payment of dividends pooled in said dividend account to the investors transfers money from aid investment money pool account to said investor wallets.

9. The public investment raising system for raising investments to fund a business as set forth in claim 8, wherein,
in case the investment money in a virtual currency is transferred into said investor wallets, the dividends in any of one of virtual currencies are paid into from said dividend account to said investor wallets.

10. The public investment raising system for raising investments to fund a business as set forth in claim 9, wherein
it is possible to select one from multiple kinds of virtual currencies with which payment is made from said dividend account to said investor wallets.

11. The public investment raising system for raising investments to fund a business as set forth in claim 8, wherein,
in case the investment money in a virtual currency is transferred into said investor wallets, the dividends in any of one of real currencies are paid into from said dividend account to said investor wallets.

12. The public investment raising system for raising investments to fund a business as set forth in claim 11, wherein
it is possible to select one from multiple kinds of real currencies with which payment is made from said dividend account to said investor wallets.

13. The public investment raising system for raising investments to fund a business as set forth in claim 1, wherein
the fund for the business is used for advertisements fees and said payee is an advertisement agency or an advertisement publisher.

14. The public investment raising system for raising investments to fund a business as set forth in claim 13, said server further comprising;
a means to connect to at least one advertisement agency terminal via a network,
a means to register on the database sub-project information regarding one or more sub-projects received from said application software provider terminal, said sub-projects inviting advertisement agencies to place advertisements for which advertisements fees are allocated in the amount obtained by dividing the total amount of investment money by the number of times of advertisements are to be placed,
a means to allow said advertisement agency terminal to browse said sub-project information registered in the database via the network,
a means to receive from said advertisement agency terminal application to said sub-projects and to allow said advertisement agency terminal to browse the applications received from said advertisement agency terminal,
a means to receive from said application software provider terminal information of applications made to said sub-projects by said advertisement agency terminal and of the advertisement fees and to store the information in the database, and
a means to transfer money from said investment money pool account to the advertisement agencies according to the information of the advertisement fees stored in the database.

15. The public investment raising system for raising investments to fund a business as set forth in claim 2, said server further comprising;
a means to send to said application software provider terminal SDKs to be incorporated in said application software, which has been registered in said server, for the purpose of retrieving performance information of said application software,
a means to retrieve the performance information of said application software from said SDKs incorporated in said application software,
a means to generate a KPI information based on the retrieved performance information, and
a means to allow said investor terminal to browse said KPI information.

16. The public investment raising system for raising investments to fund a business as set forth in claim 6, said server further comprising;
a means to calculate expected dividends on the basis of the amount of said sales distribution money, the number of project tokens owned by each investor and the total number of issued project tokens, and
a means to allow said investor terminal to browse the calculated expected dividends via the network.

17. The public investment raising system for raising investments to fund a business as set forth in claim 6, wherein
said means to store the money invested on said project by the investors in said investment money pool account transfers investment money from investor wallets made in the database to said investment money pool account, and
said means to make payment of dividends pooled in said dividend account to the investors transfers money from aid investment money pool account to said investor wallets.

18. The public investment raising system for raising investments to fund a business as set forth in claim 7, wherein
said means to store the money invested on said project by the investors in said investment money pool account transfers investment money from investor wallets made in the database to said investment money pool account, and
said means to make payment of dividends pooled in said dividend account to the investors transfers money from aid investment money pool account to said investor wallets.

19. The public investment raising system for raising investments to fund a business as set forth in claim 2, wherein
the fund for the business is used for advertisements fees and said payee is an advertisement agency or an advertisement publisher.

20. The public investment raising system for raising investments to fund a business as set forth in claim 3, wherein
the fund for the business is used for advertisements fees and said payee is an advertisement agency or an advertisement publisher.
